(19) United States
(12) Patent Application Publication
(10) Pub. No.: US 2017/0206170 A1
(43) Pub. Date: Jul. 20, 2017

(54) REDUCING A SIZE OF A LOGICAL TO PHYSICAL DATA ADDRESS TRANSLATION TABLE

(71) Applicant: Western Digital Technologies, Inc., San Jose, CA (US)

(72) Inventors: Brent W. JACOBS, Rochester, MN (US); Colin C. MCCAMBRIDGE, Rochester, MN (US)

(21) Appl. No.: 15/479,732

(22) Filed: Apr. 5, 2017

Related U.S. Application Data
(63) Continuation of application No. 14/602,092, filed on Jan. 21, 2015.

(51) Int. Cl. G06F 12/1009; G06F 12/02

(52) U.S. Cl. CPC G06F 12/1009; G06F 12/0246; G06F 2212/1044; G06F 2212/2022; G06F 2212/65; G06F 2212/7201; G06F 2212/7211; G06F 2212/7205

(57) ABSTRACT

A method may include forming, by a processor, a logical data address container comprising a plurality of logical data addresses. Each logical data address corresponds to a respective physical data address. The method also may include specifying, by the processor, a fully specified physical data address corresponding to a first logical data address of the plurality of logical data addresses. The method further may include specifying, by the processor, partially specified physical data addresses corresponding to the other logical data addresses of the plurality of logical data addresses. The partially specified physical data addresses may include sufficient address information to specify physical data addresses not directly adjacent to the fully specified physical data address. The method also may include storing the fully specified physical data address and the plurality of partially specified physical data addresses in a logical to physical data address translation table.

### CROSS-REFERENCE TO RELATED APPLICATIONS

This application is a continuation application of co-pending U.S. patent application Ser. No. 14/602,092, filed on Jan. 21, 2015, which herein is incorporated by reference.

### TECHNICAL FIELD

This disclosure relates to translation tables for translating logical data addresses to physical data addresses.

### BACKGROUND

Storage devices used in computers or other electronics devices may be non-volatile memory or volatile memory. The main difference between non-volatile memory and volatile memory is that non-volatile memory may continue to store data without requiring a persistent power supply. As a result, non-volatile memory devices have developed into a popular type of memory for a wide range of electronic applications. For instance, non-volatile memory devices, including flash memory devices, are commonly incorporated into solid-state storage devices, such as solid-state drives (SSDs).

Some storage devices utilize physical data addresses for internal mapping of data to storage locations. For example, SSDs may utilize physical block addresses to specify locations of data within the SSD. Operating systems, however, may use logical data addresses to specify logical locations of data. A controller of an SSD may maintain a logical to physical data address translation table, which associates each logical data address used by the operating system with a respective physical block address used internally by the controller of the SSD.

### SUMMARY

In some examples, the disclosure describes a method including forming, by a processor, a logical data address container comprising a plurality of logical data addresses, wherein each logical data address corresponds to a respective physical data address. The method also may include specifying, by the processor, a fully specified physical data address corresponding to a first logical data address of the plurality of logical data addresses; and specifying, by the processor, partially specified physical data addresses corresponding to the other logical data addresses of the plurality of logical data addresses, wherein partially specified physical data addresses include sufficient address information to specify physical data addresses not directly adjacent to the fully specified physical data address. In some examples, the method further may include storing the fully specified physical data address and the plurality of partially specified physical data addresses in a logical to physical data address translation table.

In some examples, the disclosure describes a storage device that includes a device configured to store a logical to physical data address translation table and a processor. The processor may be configured to form a logical data address container comprising a plurality of logical data addresses, wherein each logical data address corresponds to a respective physical data address; specify a fully specified physical data address corresponding to a first logical data address of the plurality of logical data addresses; and specify partially specified physical data addresses corresponding to the other logical data addresses of the plurality of logical data addresses. The partially specified physical data addresses may include sufficient address information to specify physical data addresses not directly adjacent to the fully specified physical data address. The processor further may be configured to store the fully specified physical data address and the plurality of partially specified data addresses in the logical to physical data address translation table.

In some examples, the disclosure describes a computer-readable storage medium that stores instructions that, when executed, cause a processor to form a logical data address container comprising a plurality of logical data addresses, wherein each logical data address corresponds to a respective physical data address; specify a fully specified physical data address corresponding to a first logical data address of the plurality of logical data addresses; and specify partially specified physical data addresses corresponding to the other logical data addresses of the plurality of logical data addresses. The partially specified physical data addresses may include sufficient address information to specify physical data addresses not directly adjacent to the fully specified physical data address. The instructions, when executed, further may cause the processor to store the fully specified physical data address and the plurality of partially specified data addresses in a logical to physical data address translation table.

In some examples, the disclosure describes a system including means for forming a logical data address container comprising a plurality of logical data addresses, wherein each logical data address corresponds to a respective physical data address; means for specifying a fully specified physical data address corresponding to a first logical data address of the plurality of logical data addresses; and means for specifying partially specified physical data addresses corresponding to the other logical data addresses of the plurality of logical data addresses. The partially specified physical data addresses may include sufficient address information to specify physical data addresses not directly adjacent to the fully specified physical data address. The system also may include means for storing the fully specified physical data address and the plurality of partially specified data addresses in a logical to physical data address translation table.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a conceptual and schematic block diagram illustrating an example storage environment in which a storage device may function as a storage device for a host device, in accordance with one or more techniques of this disclosure.

FIG. 2 is a conceptual diagram illustrating an example memory device, in accordance with one or more techniques of this disclosure.

FIG. 3 is a conceptual and schematic block diagram illustrating an example controller, in accordance with one or more techniques of this disclosure.

FIGS. 4-6 are conceptual diagrams illustrating example logical to physical data address translation table entries, in accordance with one or more techniques of this disclosure.

FIG. 7 is a flow diagram illustrating an example technique for forming a logical data address container including a plurality of logical data addresses and associating each logical data address with a respective physical data address, in accordance with one or more techniques of this disclosure.

### DETAILED DESCRIPTION

The disclosure describes techniques for reducing a size of a logical to physical data address translation table. The techniques may include grouping multiple logical data addresses in a single logical data address container. For each logical data address container, a processor may fully specify a physical data address for one of the logical data addresses. Fully specifying the physical data address may allow precise location of the physical data address in a memory. For the remaining logical data addresses, the processor may partially specify respective physical data addresses. Partially specifying these physical data addresses may prevent precise location of the respective partially specified physical data addresses without reference to the fully specified physical data address, but may reduce a size (in bits) of the partially specified physical data addresses. In this way, by reducing the number of bits required for at least some of the entries in the logical to physical data address translation table, the memory consumed by the logical to physical data address translation table may be reduced. In some examples, the processor may be a controller of a storage device and the logical to physical data address translation table may be a logical to physical data address translation table for the storage device. In other examples, the processor may be another processor, such as a general purpose processor, and the logical to physical data address translation table may be, for example, a translation lookaside buffer.

Some storage devices utilize physical data addresses for internal mapping of data to storage locations. For example, SSDs may utilize physical block addresses to specify locations of data within the SSD. A physical block address may include at least a die number, a block number, and a page number, as pages are the smallest storage unit individually addressable in many SSD. Operating systems, however, may use logical data addresses to specify logical locations of data. Because of the use of different addresses for data, a controller of a SSD may maintain a logical to physical data address translation table, which associates each logical data address used by the operating system with a respective physical block address used internally by the SSD.

As SSD capacities increase, the number of pages increases, and the number of logical to physical data address translation table entries increases correspondingly. For example, if an SSD utilizes 4 kilobyte (KB) pages and has a capacity of 1 terabyte (TB), the flash storage device has 256 million pages. The logical to physical data address translation table may thus include 256 million entries. In some examples, fully specifying the physical block address for each page may utilize 6 bytes of data. Thus, in this example, the size of the logical to physical data address translation table for a 1 TB flash storage device with 4 KB pages is about 1.5 gigabytes (GB).

In many implementations, the logical to physical data address translation table is stored in volatile memory, such as dynamic random-access memory (DRAM). However, including additional DRAM may increase a bill of materials (BOM) of the flash storage device. One alternative may be to store the logical to physical data address translation table in flash memory, but this complicates operation of the SSD, including complicating wear leveling, increasing write amplification, or the like. Additionally, storing the logical to physical data address translation table in flash memory consumes storage space otherwise available for host device or user data.

Another alternative may be to increase a page size. For example, increasing a page size from 4 KB to 16 KB would reduce the number of logical to physical data address translation table entries by a factor of 4. However, in many implementations, the physical page and the logical page must be the same size, which may result in complicating the hardware engines of the SSD, including compression and encryption engines. Additionally, increasing the page size may increase write amplification, which refers to the ratio between the amount of data received from host device to be written to the flash memory and the amount of data actually written to the flash memory, since an entire page must be written even if only a small portion of the data stored by the page is updated.

Another alternative is to string multiple small pages together in the logical to physical data address translation table. However, in some storage devices, such as SSDs, the data received from a host device may be processed in parallel, and may be written to the flash memory in a different order than it was received from the host device. This complicates associated multiple pages with sequential logical data addresses together to reduce a size of a logical to physical data address translation table.

In accordance with one or more techniques of this disclosure, a controller of a storage device may consolidate multiple logical data addresses into a logical data address container. For one of the logical data addresses, the controller may fully specify a physical data address corresponding to the logical data address. By fully specifying the physical data address, the controller may specify all location attributes such that the physical data address points to a precise location of the memory of the storage device. For the remainder of the logical data addresses in the logical data address container, the controller may partially specify the respective physical data address corresponding to each logical data address. By partially specifying the respective physical data addresses, the controller may specify sufficient address information so that, in combination with the fully specified physical data address of the one logical data address, the respective physical data addresses are fully specified. However, the partially specified physical data addresses alone may not be sufficient to point to the precise location of the memory of the storage device.

For example, a fully specified physical block address (for an SSD) may include a die number, a block number, and a page number. A partially specified physical block address may include a page number and may not include a die number or a block number. Because the partially specified physical block address is related to a fully specified physical block address by the grouping of logical block addresses in a logical block address container, the controller may infer that the die number and block number from the fully specified physical block address also applies to the partially specified physical block addresses. In this way, by reducing the number of bits required for at least some of the entries in the logical to physical block address translation table the memory consumed by the logical to physical block address translation table may be reduced.

As another example, a fully specified physical block address (for an SSD) may include a die number, a block number, and a page number. A partially specified physical block address may include an offset value, and may not include a die number, a block number, or a page number. The offset value may specify a number of pages from the previous physical block address in the address container or the fully specified physical block address, and may be signed (e.g., positive or negative) or un-signed (e.g., all values are either positive or negative).

The partially specified physical block addresses may utilize fewer bits than the fully specified physical block address. However, the partially specified physical block addresses may include sufficient bits to allow non-sequential physical block addresses to be included in a single logical block address container. By grouping multiple partially specified physical block addresses with a fully specified physical block address, the number of bits utilized for at least some of the entries in the logical to physical block address translation table is reduced, and the memory consumed by the logical to physical block address translation table may be reduced.

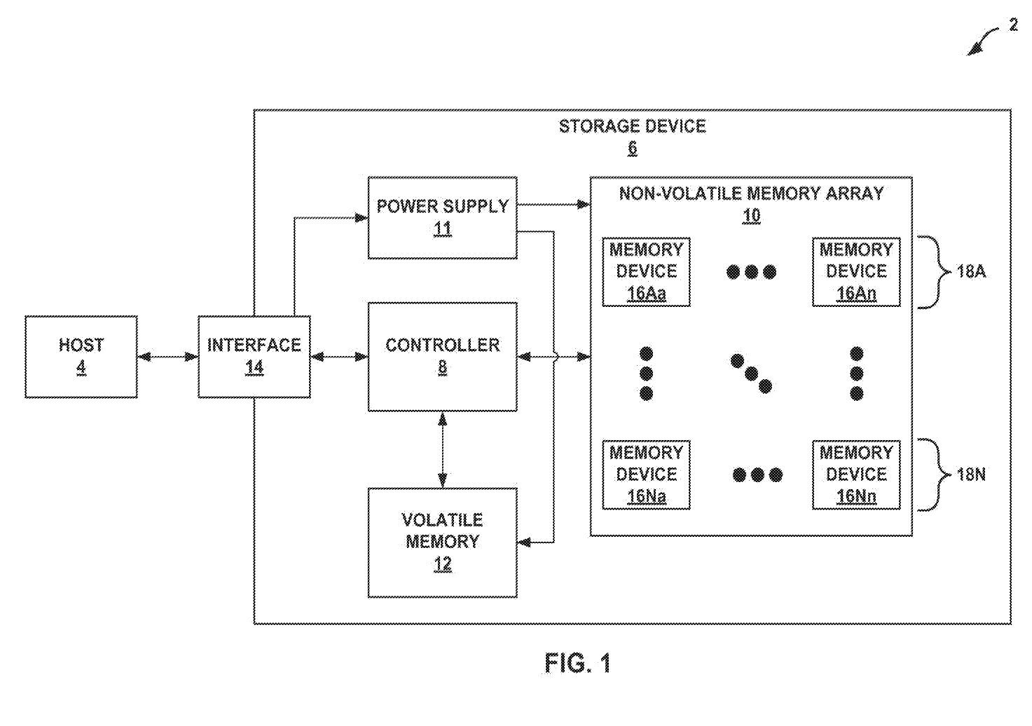

FIG. 1 is a conceptual and schematic block diagram illustrating an example storage environment 2 in which storage device 6 may function as a storage device for host device 4, in accordance with one or more techniques of this disclosure. For instance, host device 4 may utilize non-volatile memory devices included in storage device 6 to store and retrieve data. In some examples, storage environment 2 may include a plurality of storage devices, such as storage device 6, that may operate as a storage array. For instance, storage environment 2 may include a plurality of storages devices 6 configured as a redundant array of inexpensive/independent disks (RAID) that collectively function as a mass storage device for host device 4.

Storage environment 2 may include host device 4 which may store and/or retrieve data to and/or from one or more storage devices, such as storage device 6. As illustrated in FIG. 1, host device 4 may communicate with storage device 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Host device 4 may identify data stored in storage environment 2 using logical or virtual addresses.

As illustrated in FIG. 1 storage device 6 may include controller 8, non-volatile memory array 10 (NVMA 10), power supply 11, volatile memory 12, and interface 14. In some examples, storage device 6 may include additional components not shown in FIG. 1 for sake of clarity. For example, storage device 6 may include a printed board (PB) to which components of storage device 6 are mechanically attached and which includes electrically conductive traces that electrically interconnect components of storage device 6; and the like. In some examples, the physical dimensions and connector configurations of storage device 6 may conform to one or more standard form factors. Some example standard form factors include, but are not limited to, 3.5″ hard disk drive (HDD), 2.5″ HDD, 1.8″ HDD, peripheral component interconnect (PCI), PCI-extended (PCI-X), PCI Express (PCIe) (e.g., PCIe x1, x4, x8, x16, PCIe Mini Card, MiniPCI, etc.). In some examples, storage device 6 may be directly coupled (e.g., directly soldered) to a motherboard of host device 4.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA) and parallel-ATA (PATA)), Fibre Channel, small computer system interface (SCSI), serially attached SCSI (SAS), peripheral component interconnect (PCI), and PCI-express. The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit storage device 6 to receive power from host device 4. For example, as illustrated in FIG. 1, power supply 11 may receive power from host device 4 via interface 14.

Storage device 6 includes controller 8, which may manage one or more operations of storage device 6. For instance, controller 8 may manage the reading of data from and/or the writing of data to memory devices 16.

Storage device 6 may include NVMA 10, which may include a plurality of memory devices 16Aa-16Nn (collectively, “memory devices 16”). Each of memory devices 16 may be configured to store and/or retrieve data. For instance, a memory device of memory devices 16 may receive data and a message from controller 8 that instructs the memory device to store the data. Similarly, the memory device of memory devices 16 may receive a message from controller 8 that instructs the memory device to retrieve data. In some examples, each of memory devices 16 may be referred to as a die. In some examples, a single physical chip may include a plurality of dies (i.e., a plurality of memory devices 16). In some examples, each of memory devices 16 may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, memory devices 16 may include any type of non-volatile memory devices. Some examples, of memory devices 16 include, but are not limited to flash memory devices, phase-change memory (PCM) devices, resistive random-access memory (ReRAIVI) devices, magnetoresistive random-access memory (MRAM) devices, ferroelectric random-access memory (F-RAM), holographic memory devices, and any other type of non-volatile memory devices.

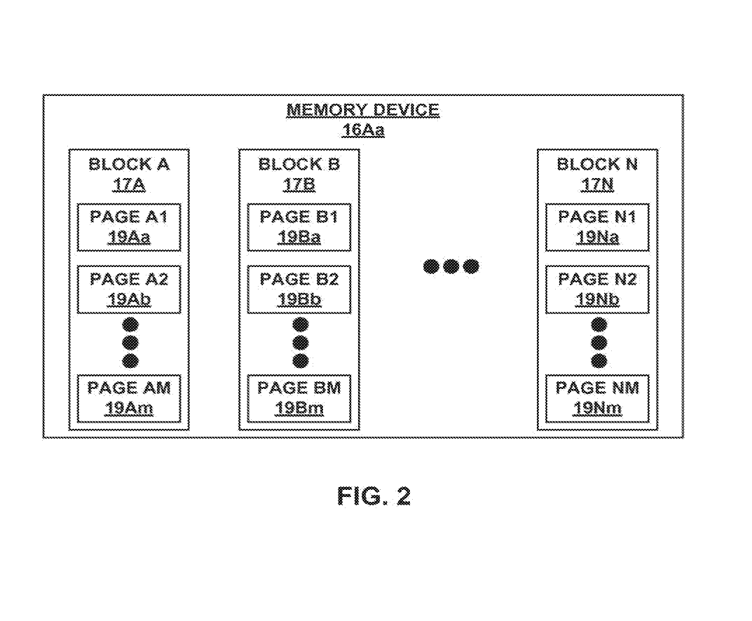

Flash memory devices may include NAND or NOR based flash memory devices, and may store data based on a charge contained in a floating gate of a transistor for each flash memory cell. In NAND flash memory devices, the flash memory device may be divided into a plurality of blocks, each of which may be divided into a plurality of pages. FIG. 2 is a conceptual block diagram illustrating an example memory device 16Aa, which includes a plurality of blocks 17A-17N (collectively, “blocks 17”), each of which is divided into a plurality of pages 19Aa-19Nm (collectively, “pages 19”). Each page of the pages 19 within a particular memory device (e.g., memory device 16Aa may include a plurality of flash memory cells. In NAND flash memory devices, rows of flash memory cells may be electrically connected using a word line to define a page of the plurality of pages 19. Respective cells in each of the pages 19 may be electrically connected to respective bit lines. Controller 8 may write data to and read data from NAND flash memory devices at the page level and erase data from NAND flash memory devices at the block level.

In some examples, it may not be practical for controller 8 to be separately connected to each memory device of memory devices 16. As such, the connections between memory devices 16 and controller 8 may be multiplexed. As an example, memory devices 16 may be grouped into channels 18A-18N (collectively, “channels 18”). For instance, as illustrated in FIG. 1, memory devices 16Aa-16An may be grouped into first channel 18A, and memory devices 16Na-16Nn may be grouped into N^{th} channel 18N. The memory devices 16 grouped into each of channels 18 may share one or more connections to controller 8. For instance, the memory devices 16 grouped into first channel 18A may be attached to a common I/O bus and a common control bus. Storage device 6 may include a common I/O bus and a common control bus for each respective channel of channels 18. In some examples, each channel of channels 18 may include a set of chip enable (CE) lines which may be used to multiplex memory devices on each channel. For example, each CE line may be connected to a respective memory device of memory devices 16. In this way, the number of separate connections between controller 8 and memory devices 16 may be reduced. Additionally, as each channel has an independent set of connections to controller 8, the reduction in connections may not significantly affect the data throughput rate as controller 8 may simultaneously issue different commands to each channel.

In some examples, storage device 6 may include a number of memory devices 16 selected to provide a total capacity that is greater than the capacity accessible to host device 4. This is referred to as over-provisioning. For example, if storage device 6 is advertised to include 240 GB of user-accessible storage capacity, storage device 6 may include sufficient memory devices 16 to give a total storage capacity of 256 GB. The 16 GB of memory devices 16 may not be accessible to host device 4 or a user of host device 4. Instead, the over-provisioned portion of storage devices 16 may provide additional blocks to facilitate writes, garbage collection, wear leveling, and the like. Further, the over-provisioned storage devices 16 may provide additional blocks that may be used if some blocks wear to become unusable and are retired from use. The presence of the additional blocks may allow retiring of the worn blocks without causing a change in the storage capacity available to host device 4. In some examples, the amount of over-provisioning may be defined as p−(T−D)/D, wherein p is the over-provisioning ratio, T is the total storage capacity of storage device 2, and D is the storage capacity of storage device 2 that is accessible to host device 4.

Storage device 6 may include power supply 11, which may provide power to one or more components of storage device 6. When operating in a standard mode, power supply 11 may provide power to the one or more components using power provided by an external device, such as host device 4. For instance, power supply 11 may provide power to the one or more components using power received from host device 4 via interface 14. In some examples, power supply 11 may include one or more power storage components configured to provide power to the one or more components when operating in a shutdown mode, such as where power ceases to be received from the external device. In this way, power supply 11 may function as an onboard backup power source. Some examples of the one or more power storage components include, but are not limited to, capacitors, super capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

Storage device 6 may include volatile memory 12, which may be used by controller 8 to store information. In some examples, controller 8 may use volatile memory 12 as a cache. For instance, controller 8 may store cached information 13 in volatile memory 12 until cached information 13 is written to memory devices 16. As illustrated in FIG. 1, volatile memory 12 may consume power received from power supply 11. Examples of volatile memory 12 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, and the like).

In some examples, controller 8 may use volatile memory 12 to store a logical to physical (or virtual to physical) data address translation table. In some examples, the logical to physical data address translation table may include entries that include a logical data address and a corresponding physical data address. In some examples, rather than each entry in the logical to physical data address translation table including a logical data address, the logical to physical data address translation table may include an index that encodes the respective logical data address of each entry in the logical to physical data address translation table. In some of these examples, the logical to physical data address translation table may not store the index value (or logical data address) with the respective entries in the logical to physical data address translation table. Host device 4 may refer to a unit of data using the logical data address, and controller 8 may utilize physical data addresses to direct writing of data to and reading of data from memory devices 16.

In accordance with one or more techniques of this disclosure, controller 8 may consolidate multiple logical data addresses into a logical data address container. For one of the logical data addresses in the logical data address container, controller 8 may fully specify a physical data address corresponding to the logical data address. By fully specifying the physical data address, controller 8 may specify all location attributes such that the physical data address points to a precise location of memory devices 16 (e.g., a precise one of memory devices 16, a precise block, a precise page, etc.). For the remainder of the logical data addresses in the logical data address container, controller 8 may partially specify the respective physical data address corresponding to each logical data address. The partially specified physical data addresses may include less information than a fully specified physical data address. By partially specifying the respective physical data addresses, controller 8 may specify sufficient address information so that, in combination with the fully specified physical data address of the one logical data address, the respective physical data addresses are fully specified. However, the partially specified physical data addresses alone may not be sufficient to point to the precise location of memory devices 16.

In this way, by reducing the number of bits required for at least some of the entries in the logical to physical data address translation table, the memory consumed by the logical to physical data address translation table may be reduced. As described above, in some examples, controller 8 may cause the logical to physical data address translation table to be stored in volatile memory 12. By reducing the memory consumed by the logical to physical data address translation table, storage device 6 may include a smaller amount of volatile memory 12.

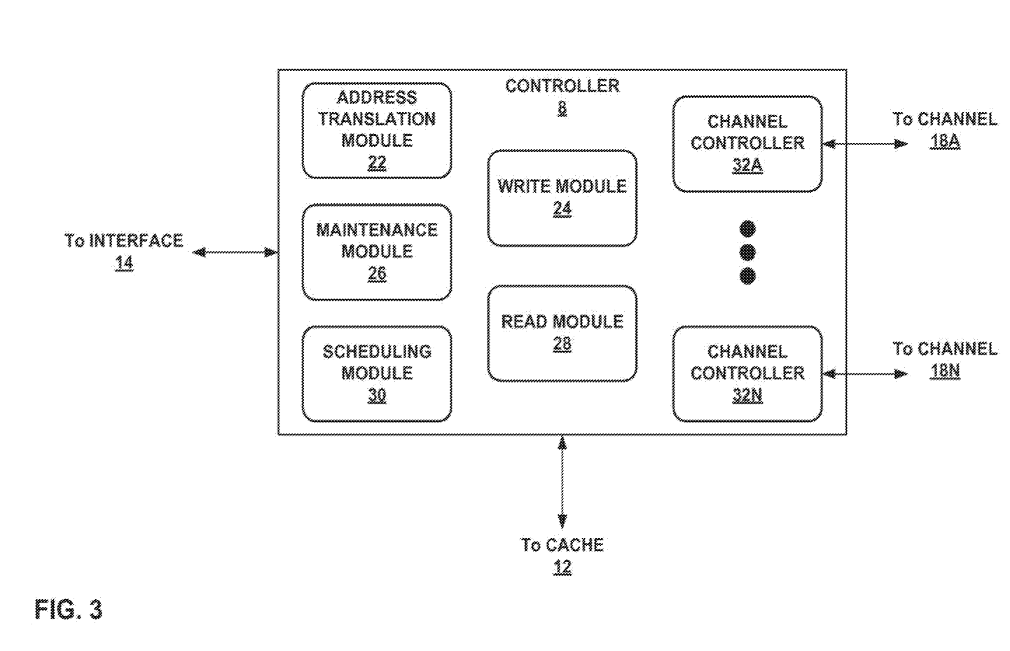

FIG. 3 is a conceptual and schematic block diagram illustrating example details of controller 8. In some examples, controller 8 may include an address translation module 22, a write module 24, a maintenance module 26, a read module 28, a scheduling module 30, and a plurality of channel controllers 32A-32N (collectively, “channel controllers 32”). In other examples, controller 8 may include additional modules or hardware units, or may include fewer modules or hardware units. Controller 8 may include a microprocessor, digital signal processor (DSP), application specific integrated circuit (ASIC), field programmable gate array (FPGA), or other digital logic circuitry. In some examples, controller 8 may be a system on a chip (SoC).

Controller 8 may interface with the host device 4 via interface 14 and manage the storage of data to and the retrieval of data from memory devices 16. For example, write module 24 of controller 8 may manage writes to memory devices 16. For example, write module 24 may receive a message from host device 4 via interface 14 instructing storage device 6 to store data associated with a logical data address and the data. Write module 24 may manage writing of the data to memory devices 16.

For example, write module 24 may communicate with address translation module 22, which manages translation between logical data addresses used by host device 4 to manage storage locations of data and physical data addresses used by write module 24 to direct writing of data to memory devices 16. Address translation module 22 of controller 8 may utilize a logical to physical data address translation table that associates logical data addresses (or logical block addresses) of data stored by memory devices 16 to physical data addresses (or physical block addresses) of data stored by memory devices 16. For example, host device 4 may utilize the logical data addresses of the data stored by memory devices 16 in instructions or messages to storage device 6, while write module 24 utilizes physical data addresses of the data to control writing of data to memory devices 16. (Similarly, read module 28 may utilize physical data addresses to control reading of data from memory devices 16.) The physical data addresses correspond to actual, physical locations of memory devices 16. In some examples, address translation module 22 may store the logical to physical data address translation table in volatile memory 12.

In this way, host device 4 may be allowed to use a static logical data address for a certain set of data, while the physical data address at which the data is actually stored may change. Address translation module 22 may maintain the logical to physical data address translation table to map the logical data addresses to physical data addresses to allow use of the static logical data address by the host device 4 while the physical data address of the data may change, e.g., due to wear leveling, garbage collection, or the like. In some examples, the logical to physical data address translation table may be a single layer table, such that by applying a hash to a logical data address received from host device 4, address translation module 22 may directly retrieve a corresponding physical data address.

As discussed above, write module 24 of controller 8 may perform one or more operations to manage the writing of data to memory devices 16. For example, write module 24 may manage the writing of data to memory devices 16 by selecting one or more blocks within memory devices 16 to store the data and causing memory devices of memory devices 16 that include the selected blocks to actually store the data. As discussed above, write module 24 may cause address translation module 22 to update the logical to physical data address translation table based on the selected blocks. For instance, write module 24 may receive a message from host device 4 that includes a unit of data and a logical data address, select a block and page within a particular memory device of memory devices 16 to store the data, cause the particular memory device of memory devices 16 to actually store the data (e.g., via a channel controller of channel controllers 32 that corresponds to the particular memory device), and cause address translation module 22 to update the logical to physical data address translation table to indicate that the logical data address corresponds to the selected physical data address within the particular memory device of memory devices 16.

In some examples, in addition to causing the data to be stored by memory devices 16, write module 24 may cause memory devices 16 to store information which may be used to recover the unit of data should one or more of the blocks fail or become corrupted. The parity information may be used to recover the data stored by other blocks. In some examples, the parity information may be an XOR of the data stored by the other blocks.

In order to write a bit with a logical value of 0 (charged) to a bit with a previous logical value of 1 (uncharged), a large current is used. This current may be sufficiently large that it may cause inadvertent changes to the charge of adjacent flash memory cells. To protect against inadvertent changes, an entire block of flash memory cells may be erased to a logical value of 1 (uncharged) prior to writing any data to cells within the block. Because of this, flash memory cells may be erased at the block level and written at the page level.

Thus, to write even an amount of data that would consume less than one page, controller 8 may cause an entire block to be erased. This may lead to write amplification, which refers to the ratio between the amount of data received from host device 4 to be written to memory devices 16 and the amount of data actually written to memory devices 16. Write amplification contributes to faster wearing of the flash memory cells than would occur with no write amplification. Wear to flash memory cells may occur when flash memory cells are erased due to the relatively high voltages used to erase the flash memory cells. Over a plurality of erase cycles, the relatively high voltages may result in changes to the flash memory cells. Eventually, the flash memory cells may wear out, such that data may no longer be written to the cells. Write amplification may be exacerbated by using larger blocks and/or pages.

One technique that controller 8 may implement to reduce write amplification and wear of flash memory cells includes writing data received from host device 4 to unused blocks or partially used blocks. For example, if host device 4 sends data to storage device 6 that includes only a small change from data already stored by storage device 6. The controller then may mark the old data as stale or no longer valid. Over time, this may reduce a number of erase operations blocks are exposed to, compared to erasing the block that holds the old data and writing the updated data to the same block.

Responsive to receiving a write command from host device 4, write module 24 may determine at which physical locations (e.g., blocks) of memory devices 16 to write the data. For example, write module 24 may request from address translation module 22 or maintenance module 26 one or more physical block addresses that are empty (e.g., store no data), partially empty (e.g., only some pages of the block store data), or store at least some invalid (or stale) data. Upon receiving the one or more physical block addresses, write module 24 may select one or more block as discussed above, and communicate a message that causes channel controllers 32A-32N (collectively, “channel controllers 32”) to write the data to the selected blocks.

Read module 28 similarly may control reading of data from memory devices 16. For example, read module 28 may receive a message from host device 4 requesting data with an associated logical data address. Address translation module 22 may convert the logical data address to a physical data address using the flash translation layer or table. Read module 28 then may control one or more of channel controllers 32 to retrieve the data from the physical data addresses. Similar to write module 24, read module 28 may select one or more blocks and communicate a message to that causes channel controllers 32 to read the data from the selected blocks.

Each channel controller of channel controllers 32 may be connected to a respective channel of channels 18. In some examples, controller 8 may include the same number of channel controllers 32 as the number of channels 18 of storage device 2. Channel controllers 32 may perform the intimate control of addressing, programming, erasing, and reading of memory devices 16 connected to respective channels, e.g., under control of write module 24, read module 28, and/or maintenance module 26.

Maintenance module 26 may be configured to perform operations related to maintaining performance and extending the useful life of storage device 6 (e.g., memory devices 16). For example, maintenance module 26 may implement at least one of wear leveling or garbage collection.

As described above, erasing flash memory cells may use relatively high voltages, which, over a plurality of erase operations, may cause changes to the flash memory cells. After a certain number of erase operations, flash memory cells may degrade to the extent that data no longer may be written to the flash memory cells, and a block including those cells may be retired (no longer used by controller 8 to store data). To increase the amount of data that may be written to memory devices 16 before blocks are worn and retired, maintenance module 26 may implement wear leveling.

In wear leveling, maintenance module 26 may track a number of erases of or writes to a block or a group of blocks, for each block or group of blocks. Maintenance module 26 may cause incoming data from host device 4 to be written to a block or group of blocks that has undergone relatively fewer writes or erases, to attempt to maintain the number of writes or erases for each block or group of blocks approximately equal. This may cause each block of memory devices 16 to wear out at approximately the same rate, and may increase the useful lifetime of storage device 6.

Although this may reduce write amplification and wear of flash memory cells by reducing a number of erases and writing data to different blocks, this also may lead to blocks including some valid (fresh) data and some invalid (stale) data. To combat this, maintenance module 26 may implement garbage collection. In a garbage collection operation, maintenance module 26 may analyze the contents of the blocks of memory devices 16 to determine a block that contain a high percentage of invalid (stale) data. Maintenance module 26 then may rewrite the valid data from the block to a different block, and then erase the block. This may reduce an amount of invalid (stale) data stored by memory devices 16 and increase a number of free blocks, but also may increase write amplification and wear of memory devices 16.

Scheduling module 30 of controller 8 may schedule operations to be performed by memory devices 16. For instance, scheduling module 30 may cause one or more of memory devices 16 to perform one or more operations based on requests received from other components of controller 8. In some examples, scheduling module 30 may cause a particular memory device of memory devices 16 to perform one or more operations by causing a channel controller corresponding to the particular memory device to output commands to the particular memory device. As one example, scheduling module 30 may permit channel controller 32A to output commands that cause memory device 16Aa to store data.

In accordance with one or more techniques of this disclosure, controller 8 may consolidate multiple logical data addresses into a logical data address container. For one of the logical data addresses in the logical data address container, controller 8 may fully specify a physical data address corresponding to the logical data address. By fully specifying the physical data address, controller 8 may specify all location attributes such that the physical data address points to a precise location of memory devices 16 (e.g., a precise one of memory devices 16, a precise block, a precise page, etc.). For the remainder of the logical data addresses in the logical data address container, controller 8 may partially specify the respective physical data address corresponding to each logical data address. The partially specified physical data addresses may include less information than a fully specified physical data address. By partially specifying the respective physical data addresses, controller 8 may specify sufficient address information so that, in combination with the fully specified physical data address of the one logical data address, the respective physical data addresses are fully specified. However, the partially specified physical data addresses alone may not be sufficient to point to the precise location of memory devices 16.

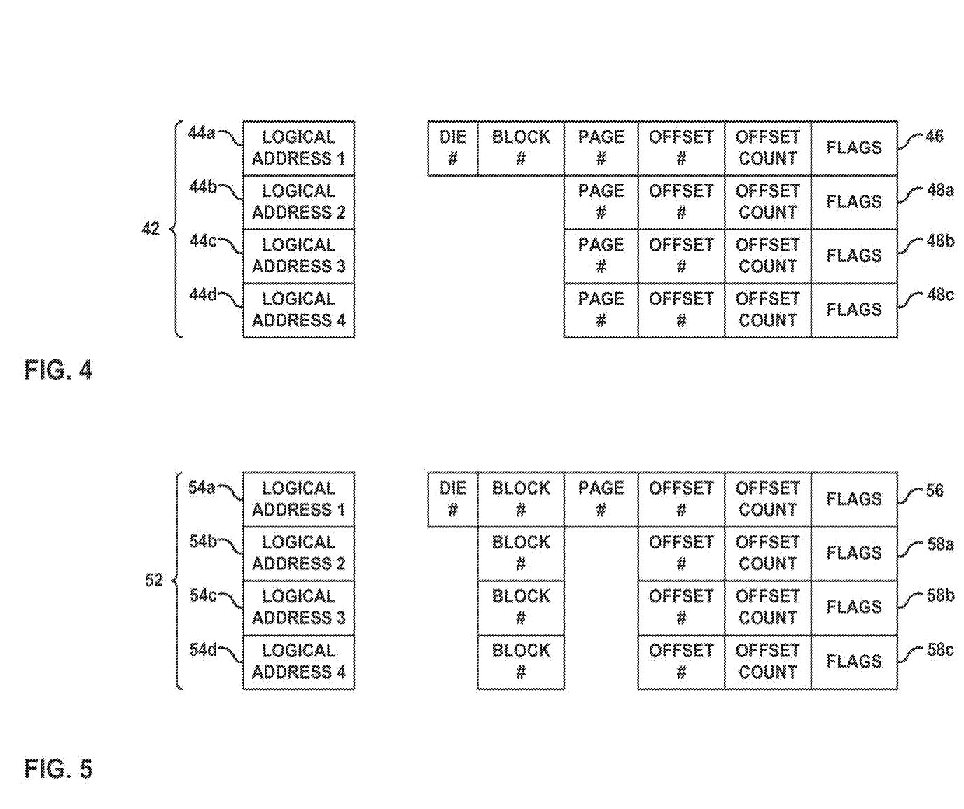

The selection of the particular location information to include in the partially specified physical data address may be based at least in part on the architecture of storage device 6 (FIG. 1), including the architecture of controller 8 and non-volatile memory array 10. For example, controller 8 may be architected to select a particular block of blocks 17 (FIG. 2), and write to pages 19 within the particular block. FIG. 4 is a conceptual diagram illustrating an example logical to physical data address translation table entry, for an architecture in which controller 8 is configured to select a particular block of blocks 17 (FIG. 2), and write to pages 19 within the particular block.

The logical to physical data address translation table entry illustrated in FIG. 4 includes a logical data address container 42, which includes a plurality of logical data addresses 44a-44d (collectively, “logical data addresses 44”). Although logical data address container 42 includes four logical data addresses 44, in other examples, logical data address container 42 may include another number of logical data addresses 44. In general, logical data address container 42 may include a plurality of logical data addresses 44. In some examples, logical data address container 42 may include sequential logical data addresses. In some examples, rather than each entry in the logical to physical data address translation table including a respective one of logical data addresses 44, the logical to physical data address translation table may include an index that encodes the respective logical data address of each entry in the logical to physical data address translation table. In some of these examples, the logical to physical data address translation table may not store the index value (or logical data address) with the respective entries in the logical to physical data address translation table.

Each of logical data addresses 44 is associated with a respective physical data address. In the example shown in FIG. 4, first logical data address 44a is associated with a fully specified physical data address 46, and each of second, third, and fourth logical data addresses 44b-44d are associated with a respective partially specified physical data address 48a-48c (collectively, “partially specified physical data addresses 48”). In some examples, rather than first logical data address 44a being associated with fully specified physical data address 46, another logical data address of logical data addresses 44 may be associated with fully specified physical data address 46, and the remainder of logical data addresses 44 may be associated with respective partially specified physical data address.

Fully specified physical data address 46 fully specifies the physical location in memory devices 16 of data specified by first logical data address 44a. In other words, fully specified physical data address 46 alone, without additional information from another physical data address, is sufficient to allow location of the data in memory devices 16. In the example shown in FIG. 4, fully specified physical data address 46 includes a die number, a block number, a page number, an offset number, an offset count, and flags.

The die number refers to the physical die (e.g., memory device of memory devices 16) on which the data referenced by the fully specified physical data address 46 is located. The number of bits used to identify the memory device or physical die may depend at least in part on the number of memory devices 16 to which controller 8 is connected. For example, a storage device 6 may include 64 dies (memory devices 16), and may utilize six bits to identify the respective memory devices 16. In other examples, a storage device 6 may include 32 dies (memory devices 16), and may utilize five bits to identify the respective memory devices 16, may include 16 dies (memory devices 16), and may utilize four bits to identify the respective memory devices 16, or the like.

The block number refers to the block within a particular physical die (memory device of memory devices 16) at which the data referenced by the fully specified physical data address 46 is located. The number of bits used to identify the block may depend at least in part on the number of blocks 17 (FIG. 2) in each memory device of memory devices 16. For example, each memory device of memory devices 16 may include 2048 blocks 17, and may utilize eleven bits to identify the respective blocks 17. In other examples, each memory device of memory devices 16 may include 1024 blocks 17, and may utilize ten bits to identify the respective blocks 17, may include 4096 blocks 17, and may utilize twelve bits to identify the respective blocks 17, or the like.

The page number refers to the page within a particular block (memory device of memory devices 16) at which the data referenced by the fully specified physical data address 46 is located. The number of bits used to identify the page may depend at least in part on the number of pages 19 (FIG. 2) in each respective block of blocks 17. For example, each block of blocks 17 may include 4096 pages 19, and may utilize twelve bits to identify the respective pages 19. In other examples, each block of blocks 17 may include 2048 pages 19, and may utilize eleven bits to identify the respective pages 19, may include 8192 blocks 17, and may utilize thirteen bits to identify the respective pages 19, or the like.

In some examples, the fully specified physical data address 46 also may optionally include an offset number. In some implementations, each page of pages 19 within a block of blocks 19 may be divided into a plurality of smaller units, such as 512 byte units. The offset number may refer to the number of units, counted from the beginning of the page, at which the data identified by the fully specified physical data address 46 begins. For example, in an implantation in which a page includes 16,384 bytes, the page may include 32 units, each unit including 512 bytes. In some of these examples, the offset number may be identified using five bits. In other examples, e.g., depending at least partially upon the number of units, the offset number may be identified using a different number of bits. In some examples, a fully specified physical data address 46 may not include an offset number.

In some examples, the fully specified physical data address 46 also may optionally include an offset count. The offset count may not be utilized in a physical data address in examples in which an offset number is not utilized in the physical data address. Additionally, in some examples in which an offset number is utilized, an offset count still may not be utilized.

The offset count may be used to specify the number of units consumed by the data referred to by the logical data address. The number of units consumed by the data may not always be the same. For example, some data may be compressible, and controller 8 may compress the data before causing the data to be written to memory devices 16. For example, each logical data address may correspond to 4 kilobyte (KB) of data. However, in some examples, controller 8 may be able to compress the 4 KB to smaller size, such as 2 KB or the like. Thus, the data referred to by the logical data address may total 4 KB, but may consume a smaller amount of memory devices 16. In some examples, the offset count may be identified using three bits. In other examples, the offset count may be identified using a different number of bits.

The fully specified physical data address 46 also may optionally include flags. The flags may include additional information regarding the data identified by the fully specified physical data address 46 and corresponding first logical data address 44a. For example, the flags may include an indication of whether the data stored at the location specified by fully specified physical data address 46 is still valid, or if it is stale. In some examples, the flags may be identified using six bits. In other examples, the flags may be identified using a different number of bits. In some examples, fully specified physical data address 46 may not include flags.

In the example illustrated in FIG. 4, each of partially specified physical data addresses 48 omits the die number and the block number. However, each of partially specified physical data addresses 48 includes the page number, the offset number, the offset count, and the flags. In other examples, as described above, the partially specified physical data addresses 48 may omit one or more of the offset number, the offset count, or the flags (e.g., when the fully specified physical data address 46 omits one or more of the offset number, the offset count, or the flags). Because controller 8 may be configured to select a particular memory device of memory devices 16 and a particular block of blocks 17 to write to for a set of data, logical data addresses within the set of data may be grouped in the logical data address container 42, and the corresponding partially specified physical data addresses 48 may omit the die number and the block number, as these will remain the same for each physical data address in the logical data address container 42. By omitting the die number and the block number, the number of bits may be reduced.

For example, four fully specified physical data addresses may consume 43 bits each (6 bits for the die number, 11 bits for the block number, 12 bits for the page number, 5 bits for the offset number, 3 bits for the offset count, and 6 bits for the flags). Thus, each fully specified physical data address may consume 6 bytes, and four fully specified physical data addresses may consume 24 bytes.

On the other hand, by grouping four logical data addresses 44 into a logical data address container 42, fully specifying a first physical data address 46, and partially specifying three physical data addresses 48, fewer bytes may be consumed. For example, the fully specified physical data address still may consume 43 bits (6 bits for the die number, 11 bits for the block number, 12 bits for the page number, 5 bits for the offset number, 3 bits for the offset count, and 6 bits for the flags). However, each of the partially specified physical data addresses 48 may omit 17 bits (6 bits for the die number and 11 bits for the block number). Thus, each of partially specified physical data addresses 48 may consume 26 bits, or 4 bytes. Thus, the number of bits consumed by the physical data addresses for the logical data address container may be 18 bytes, a savings of 6 bytes.

In other examples, controller 8 may be configured to write data to memory devices 16 by selecting a die (e.g., a particular memory device of memory devices 16), a particular page of pages 19, and writing data to the respective particular page across a plurality of blocks 17. FIG. 5 is a conceptual diagram illustrating an example logical to physical data address translation table entry, for an architecture in which controller 8 is configured to select a particular page of pages 19 (FIG. 2), and write to the particular page across a plurality of blocks 17.

The logical to physical data address translation table entry illustrated in FIG. 5 includes a logical data address container 52, which includes a plurality of logical data addresses 54a-54d (collectively, “logical data addresses 54”). Although logical data address container 52 includes four logical data addresses 54, in other examples, logical data address container 52 may include another number of logical data addresses 54. In general, logical data address container 52 may include a plurality of logical data addresses 54. In some examples, logical data address container 52 may include sequential logical data addresses. In some examples, rather than each entry in the logical to physical data address translation table including logical data addresses 54, the logical to physical data address translation table may include an index that encodes the respective logical data address of each entry in the logical to physical data address translation table. In some of these examples, the logical to physical data address translation table may not store the index value (or logical data address) with the respective entries in the logical to physical data address translation table.

Each of logical data addresses 54 is associated with a respective physical data address. In the example shown in FIG. 5, first logical data address 54a is associated with a fully specified physical data address 56, and each of second, third, and fourth logical data addresses 54b-54d are associated with a respective partially specified physical data address 58a-58c (collectively, “partially specified physical data addresses 58”). In some examples, rather than first logical data address 54a being associated with fully specified physical data address 56, another logical data address of logical data addresses 54 may be associated with fully specified physical data address 56, and the remainder of logical data addresses 54 may be associated with respective partially specified physical data address 58.

Fully specified physical data address 56 fully specifies the physical location in memory devices 16 of data specified by first logical data address 54a. In other words, fully specified physical data address 56 alone, without additional information from another physical data address, is sufficient to allow location of the data in memory devices 16. In the example shown in FIG. 5, fully specified physical data address 56 includes a die number, a block number, a page number, an offset number, an offset count, and flags.

In the example illustrated in FIG. 5, each of partially specified physical data addresses 58 omits the die number and the page number. However, each of partially specified physical data addresses 58 includes the block number, the offset number, the offset count, and the flags. In other examples, as described above, the partially specified physical data addresses 58 may omit one or more of the offset number, the offset count, or the flags (e.g., when the fully specified physical data address 46 omits one or more of the offset number, the offset count, or the flags). Because controller 8 may be configured to select a particular memory device of memory devices 16 and a particular page of pages 19 to write to for a set of data, logical data addresses within the set of data may be grouped in the logical data address container 52, and the corresponding partially specified physical data addresses 58 may omit the die number and the page number, as these will remain the same for each physical data address in the logical data address container 5. By omitting the die number and the page number, the number of bits may be reduced.

For example, four fully specified physical data addresses may consume 43 bits each (6 bits for the die number, 11 bits for the block number, 12 bits for the page number, 5 bits for the offset number, 3 bits for the offset count, and 6 bits for the flags). Thus, each fully specified physical data address may consume 6 bytes, and four fully specified physical data addresses may consume 24 bytes.

On the other hand, by grouping four logical data addresses 54 into a logical data address container 52, fully specifying a first physical data address 56, and partially specifying three physical data addresses 58, fewer bytes may be consumed. For example, the fully specified physical data address still may consume 43 bits (6 bits for the die number, 11 bits for the block number, 12 bits for the page number, 5 bits for the offset number, 3 bits for the offset count, and 6 bits for the flags). However, each of the partially specified physical data addresses 58 may omit 18 bits (6 bits for the die number and 12 bits for the page number). Thus, each of partially specified physical data addresses 58 may consume 25 bits, or 4 bytes. Thus, the number of bits consumed by the physical data addresses for the logical data address container may be 18 bytes, a savings of 6 bytes.

In this way, by reducing the number of bits required for at least some of the entries in the logical to physical data address translation table, the memory consumed by the logical to physical data address translation table may be reduced. As described above, in some examples, controller 8 may cause the logical to physical data address translation table to be stored in volatile memory 12. By reducing the memory consumed by the logical to physical data address translation table, storage device 6 may include a smaller amount of volatile memory 12.

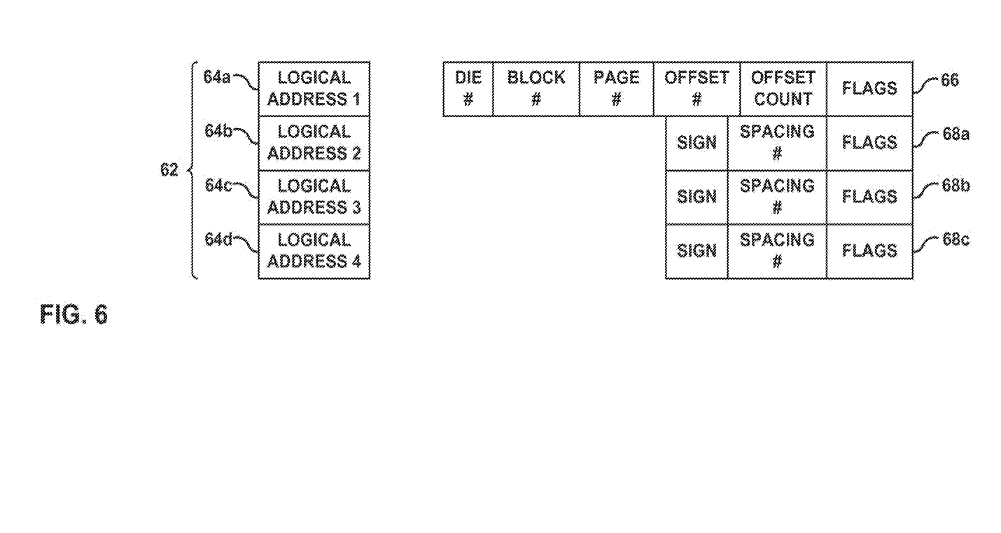

In some examples, the partially specified physical data addresses may include less location information, which may further reduce the amount of memory consumed by the partially specified physical data addresses. FIG. 6 is a conceptual diagram illustrating an example logical to physical data address translation table entry, for an architecture in which controller 8 is configured to select a particular block of blocks 17 (FIG. 2), and write to the particular block across one or more of pages 19.

The logical to physical data address translation table entry illustrated in FIG. 6 includes a logical data address container 62, which includes a plurality of logical data addresses 64a-64d (collectively, “logical data addresses 64”). Although logical data address container 62 includes four logical data addresses 64, in other examples, logical data address container 62 may include another number of logical data addresses 64. In general, logical data address container 62 may include a plurality of logical data addresses 64. In some examples, logical data address container 62 may include sequential logical data addresses. In some examples, rather than each entry in the logical to physical data address translation table including logical data addresses 64, the logical to physical data address translation table may include an index that encodes the respective logical data address of each entry in the logical to physical data address translation table. In some of these examples, the logical to physical data address translation table may not store the index value (or logical data address) with the respective entries in the logical to physical data address translation table.

Each of logical data addresses 64 is associated with a respective physical data address. In the example shown in FIG. 6, first logical data address 64a is associated with a fully specified physical data address 66, and each of second, third, and fourth logical data addresses 64b-64d are associated with a respective partially specified physical data address 68a-68c (collectively, “partially specified physical data addresses 68”). In some examples, rather than first logical data address 64a being associated with fully specified physical data address 66, another logical data address of logical data addresses 64 may be associated with fully specified physical data address 66, and the remainder of logical data addresses 64 may be associated with respective partially specified physical data address 68.

Fully specified physical data address 66 fully specifies the physical location in memory devices 16 of data specified by first logical data address 64a. In other words, fully specified physical data address 66 alone, without additional information from another physical data address, is sufficient to allow location of the data in memory devices 16. In the example shown in FIG. 6, fully specified physical data address 66 includes a die number, a block number, a page number, an offset number, an offset count, and flags.

In the example illustrated in FIG. 6, each of partially specified physical data addresses 68 omits the die number, the block number, the page number, the offset number, and the offset count. Each of partially specified physical data addresses 68 includes a sign, a spacing number, and flags.

The respective spacing number may indicate a spacing between the respective partially specified physical data address of partially specified physical data addresses 68 and another physical data address. The spacing indicated by the spacing number may be a number of pages, a number of offsets, or the like. In some examples, each respective spacing number indicates a spacing between the respective partially specified physical data address and the fully specified physical data address 66. This may allow data represented by the respective physical data addresses to be reordered on memory devices 16 without requiring reordering of the logical data addresses and physical data addresses.

The sign is an optional data field, and may represent a direction in which the spacing number is to be applied. For example, a negative sign for a respective partially specified physical data address may indicate that the partially specified physical data address indicates a location before or above the fully specified physical data address 66. Conversely, a positive sign for a respective partially specified physical data address may indicate that the partially specified physical data address indicates a location after or below the fully specified physical data address 66.

In other examples, each respective spacing number indicates a spacing between the respective partially specified physical data address and the previous physical data address. For example, the spacing number for first partially specified physical data address 68a may indicate the spacing from fully specified physical data address 66, the spacing number for second partially specified physical data address 68b may indicate the spacing from first partially specified physical data address 68a, etc. This may reduce the number of bits used for the spacing number, but may rely on the logical data addresses and corresponding physical data addresses being ordered.

Regardless of the information included in the partially specified physical data address, the information partially specified physical data address may be selected based at least in part on the architecture of controller 8 and memory devices 16, as described above. Further, the information included in the partially specified physical data address may be selected such that a partially specified physical data address in combination with a fully specified physical data address permits precise locating of the data associated with the corresponding logical data address.

The number of bits used to represent each field in the partially specified data address may be selected based at least partially on considerations including the desired size of the logical to physical data address translation table, the flexibility desired in the write order and spacing of the data associated with a logical data address container, the primary expected workload for the storage device 6, or the like. For example, referring to the example logical to physical data address translation table entry shown in FIG. 6, the number of bits used for the spacing number may be selected based at least partially on considerations including the desired size of the logical to physical data address translation table, the flexibility desired in the write order and spacing of the data associated with a logical data address container, the primary expected workload for the storage device 6, or the like. If more bits are used for the spacing number, this may increase the size of the logical to physical data address translation table, increase the flexibility with respect to how close the data associated with the logical data address container 62 must be written to memory devices 16 while allowing use of the logical address container 62, and may facilitate use of storage device 6 in an environment in which random reads and/or writes are expected to be more common than sequential reads and/or writes. On the other hand, if fewer bits are used for the spacing number, this may decrease the size of the logical to physical data address translation table, decrease the flexibility with respect to how close the data associated with the logical data address container 62 must be written to memory devices 16 while allowing use of the logical address container 62, and may facilitate use of storage device 6 in an environment in which sequential reads and/or writes are expected to be more common than random reads and/or writes. Similar considerations may impact selection of the number of bits used for the page number for the partially specified physical data addresses 48 in FIG. 4 and the number of bits used for the block number for the partially specified physical data addresses 58 in FIG. 5.

Because the number of bits used for the respective data fields in the partially specified physical data addresses 48, 58, and 68 may impact performance of storage device 6 and the size of the logical to physical data address translation table, in some examples, a single storage device 6 or a storage environment 2 including multiple storage devices 6 may be partitioned into multiple storage spaces or namespaces. In some examples, the workload of different namespaces may be predicted to be different. For example, a first namespace may be expected to experience a primarily random workload and a second namespace may be expected to experience a primarily sequential workload. In this example, the first namespace may utilize logical data address containers in which the partially specified physical data addresses utilize more bits (allowing more flexibility in write locations of data associated with the logical data address containers while utilizing more space for the logical to physical data address translation table), while the second namespace utilize logical data address containers in which the partially specified physical data addresses utilize fewer bits (allowing less flexibility in write locations of data associated with the logical data address containers while utilizing less space for the logical to physical data address translation table).

In any case, regardless of the number of bits used for the respective data fields in the partially specified physical data addresses 48, 58, and 68, the partially specified physical data addresses 48, 58, and 68 may include sufficient address information to allow data associated with a respective one of logical data address containers 42, 52, or 62 to be stored at physical locations that are not directly adjacent to the fully specified physical data address 46, 56, or 66. This may allow controller 8 more flexibility in writing data associated with a logical data address container to memory devices 16. For example, controller 8 may receive multiple write requests at substantially the same time from host device 4. The write requests may be received by controller 8 in a sequential order, and controller 8 may group multiple, sequentially received logical data addresses into a logical data address container. However, write module 24 may cause data to be written to pages 19 of memory devices 16 in a different order than the write requests were received by controller 8, e.g., due to processing of data by controller 8, such as compression. Thus, by allowing partially specified physical data addresses 48, 58, or 68 to specify locations that are not directly adjacent to the fully specified physical data address (and/or each other), controller 8 may be allowed more flexibility in writing data to memory devices 16. Similarly, by allowing partially specified physical data addresses 48, 58, or 68 to specify locations that are not directly adjacent to the fully specified physical data address (and/or each other), controller 8 may rewrite only data associated with less than all of the logical data address container 42, 52, or 62 (e.g., data associated with only one of the logical data addresses 44, 54, or 64), instead of rewriting all data associated with all logical data addresses 44, 54, or 64 in a logical data address container 42, 52, or 62.

With respect to the examples illustrated in FIGS. 4-6, in some examples, instead of including separate die numbers, block numbers, page numbers, etc., at least some of this information may be combined or simplified in the fully specified physical data address while still fully specifying the location of the data. For example, the die number and block number may be multiplied together to form another number, and this number may be included in the fully specified physical data address in place of the die number and block number. This may reduce the size of the fully specified physical data address while still fully specifying the physical location of the data.

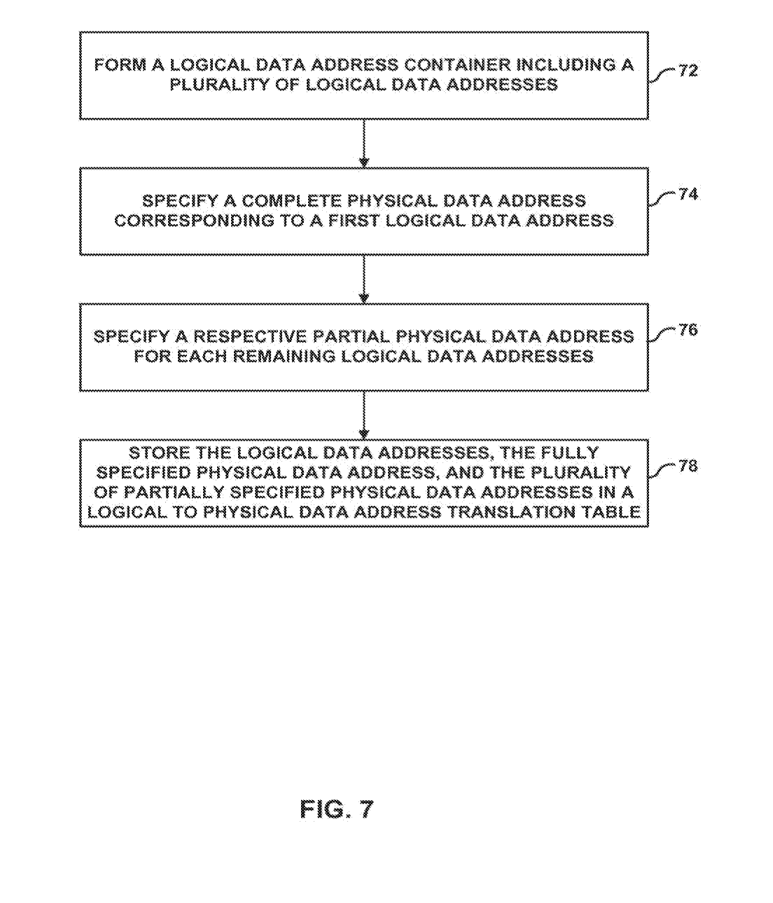

FIG. 7 is a flow diagram illustrating an example technique for forming a logical data address container including a plurality of logical data addresses and associating each logical data address with a respective physical data address, in accordance with one or more techniques of this disclosure. The technique of FIG. 7 will be described with concurrent reference to FIGS. 1-4 for ease of illustration. However, it will be appreciated that the technique of FIG. 7 may be implemented in a storage environment 2 or by a controller 8 including a different configuration than that illustrated in FIGS. 1 and 3, with a logical to physical data address translation table entry different than that illustrated in FIG. 4, or both.

The technique of FIG. 7 includes forming a logical data address container 42 including a plurality of logical data addresses 44 (72). In some examples, controller 8 may form a logical data address container 42 including sequential logical data addresses 44. In other examples, controller 8 may form a logical data address container 42 including non-sequential logical data addresses 44. As described above, although logical data address container 42 is illustrated as including four logical data addresses 44, in general, logical data address container 42 may include any number of logical data addresses 44 (e.g., at least two logical data addresses 44).

The technique of FIG. 7 also includes specifying a complete or fully specified physical data address corresponding to a first physical data address (74). In the example illustrated in FIG. 4, controller 8 specifies a fully specified physical data address 46 including a die number, a block number, a page number, an offset number, an offset count, and flags for a first logical data address 44a. In other examples, controller 8 may specify a fully specified physical data address for another logical data address of logical data addresses 44. Additionally or alternatively, a fully specified physical data address 46 may omit one or more of the fields shown in FIG. 4 (such as the offset number or offset count), may include one or more other fields not shown in FIG. 4, or both.

The technique of FIG. 7 further includes specifying a respective partially specified physical address for each remaining logical data address (76). In the example illustrated in FIG. 4, controller 8 specifies partially specified physical data addresses 48 including a page number, an offset number, an offset count, and flags for a first logical data address 44a. In other examples, a partially specified physical data address of partially specified physical data addresses 48 may omit one or more of the fields shown in FIG. 4 (such as the offset number or offset count), may include one or more other fields not shown in FIG. 4, or both. For example, other partially specified physical data addresses 58 and 68 are illustrated in FIGS. 5 and 6. Each partially specified physical data address is associated with a respective logical data address. Additionally, each respective partially specified physical data address, in combination with the fully specified physical address, includes sufficient information to precisely locate the physical location of the data associated with the respective logical data address. In some examples, each partially specified physical data addresses may include sufficient address information to allow data associated with a respective one of logical data address container to be stored at physical locations that are not directly adjacent to the fully specified physical data address 46 (and/or to other partially specified physical data addresses 48).

The technique of FIG. 7 also includes storing the logical data addresses 44, the fully specified physical data address 46, and the partially specified physical data addresses 48 in a logical to physical data address translation table (78). As described above, in some examples, the logical to physical data address translation table is stored in volatile memory 12.

Although the foregoing examples have been described with respect to a controller of a storage device, in other examples, the examples described herein may be implemented by another processor, such as a general purpose processor, and the logical to physical data address translation table may be, for example, a translation lookaside buffer.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method of maintaining a logical-to-physical address translation table by a controller within a data storage device, comprising:
receiving a set of data with a plurality of logical data addresses;
grouping the logical data addresses in a logical data address container;
forming a translation table from the logical data addresses, the translation table comprising a fully specified physical data address and a partially specified physical data address; and
storing the translation table in a volatile memory.

2. The method of claim 1, wherein the fully specified physical data address and the partially specified physical data address are changed due to wear leveling.

3. The method of claim 1, wherein the fully specified physical data address and the partially specified physical data address are changed due to garbage collection.

4. The method of claim 1, further comprising:
updating the translation table, wherein updating the translation table comprises:
changing the fully specified physical data address; and
changing the partially specified physical data address.

5. The method of claim 4, wherein the updating the translation table further comprises maintaining the logical data addresses as static logical data addresses.

6. A data storage device, comprising:
a volatile memory;
a non-volatile memory;
a controller; and
a non-transitory computer readable storage medium containing instructions that, when executed by the controller, cause the controller to store in the volatile memory a translation table, the translation table comprising a first logical address corresponding to a fully specified physical data address and a second logical address corresponding to a partially specified physical data address.

7. The data storage device of claim 6, wherein the first logical address and the second logical address are non-sequential logical addresses.

8. The data storage device of claim 6, wherein the fully specified physical data address and the partially specified physical data address are non-sequential physical addresses.

9. The data storage device of claim 6, wherein the translation table further comprises an index encoding the first logical address and the second logical address.

10. The data storage device of claim 6, wherein the controller further comprises a translation module, the translation module storing the translation table in the volatile memory.

11. A non-transitory computer readable storage medium containing instructions that, when executed by a controller of a data storage device, performs the following method:
receiving a unit of data and a logical data address;
selecting a block and a page within a non-volatile memory;
storing the unit of data within the block and the page of the non-volatile memory; and
updating a translation table stored in a volatile memory, the translation table comprising a fully specified physical data address and a partially specified physical data address.

12. The non-transitory computer readable storage medium of claim 11, wherein the fully specified physical data address and the partially specified physical data each contain a flag.

13. The non-transitory computer readable storage medium of claim 12, wherein the flag indicates that the unit of data is invalid.

14. The non-transitory computer readable storage medium of claim 11, wherein the partially specified physical data contains an offset value.

15. The non-transitory computer readable storage medium of claim 14, wherein the offset value is signed.

16. A data storage device, comprising:
a volatile memory;
a non-volatile memory;
a controller; and
a means for partially specifying physical data addresses corresponding to logical data addresses, wherein the means for partially specifying is stored in the volatile memory.

17. The data storage device of claim 16, wherein the controller stores the means for partially specifying in the volatile memory.

18. The data storage device of claim 16, further comprising a means for updating physical data addresses.

19. The data storage device of claim 16, further comprising a means for flagging physical data addresses that are invalid.

20. The data storage device of claim 16, further comprising a means for reducing erase operations to the non-volatile memory.
